(19) United States
(12) Patent Application Publication
(10) Pub. No.: US 2017/0313124 A1
(43) Pub. Date: Nov. 2, 2017

(54) SOLID CARBON REAR WHEEL COMPRISING A POLYGONALLY OUTSIDE CONTOURED HUB

(71) Applicant: CarboFibretec GmbH, Friedrichshafen (DE)

(72) Inventors: Gregor MENZEL, Friedrichshafen (DE); Thomas LESCHIK, Friedrichshafen (DE); Erhard WISSLER, Friedrichshafen (DE); Robert BASTIAN, Friedrichshafen (DE); Michael HÜBNER, Friedrichshafen (DE); Borris KÖPPER, Friedrichshafen (DE)

(21) Appl. No.: 15/497,731

(22) Filed: Apr. 26, 2017

(30) Foreign Application Priority Data
Apr. 29, 2016 (DE) 102016108052.7

(51) Int. Cl. B60B 1/04; B60B 1/00; B60B 5/02; B60B 7/00; B60B 27/00; B60B 27/02

(52) U.S. Cl. CPC B60B 1/042; B60B 5/02; B60B 7/0013; B60B 1/003; B60B 2360/3416; B60B 27/023; B60B 27/0015; B60B 2360/3418; B60B 2900/111; B60B 2900/311; B60B 2360/3412

(57) ABSTRACT

The invention relates to a drive wheel for a bike, comprising a rim which is fastened to a hub by means of a plurality of spokes, wherein the spokes are made of reinforcing fibers embedded in resin, the reinforcing fibers of a spoke extending from a first fastening portion at the rim to a second fastening portion offset against the former in the circumferential direction and being guided along the outside of the hub, wherein the hub takes a shape polygonal in cross-section on the outside to which an axial side of each spoke is adjacent. The invention further relates to a bicycle comprising said drive wheel configured as a rear wheel.

### CROSS-REFERENCE TO RELATED APPLICATIONS

This application claims priority of German Application No. DE 102016108052.7, filed on Apr. 29, 2016, which is incorporated herein by reference in its entirety.

The invention relates to a drive wheel/rear wheel for a bike such as a bicycle, for example a racing bicycle, a time trial bicycle, a triathlon bicycle, a mountain bike or a trekking bicycle, comprising a rim which is preferably made of reinforcing fibers embedded in resin, wherein the rim is fastened by means of a plurality of spokes to a hub which is preferably made of a metallic material such as an aluminum or steel alloy, wherein the spokes consist of reinforcing fibers embedded in resin, the reinforcing fibers of one spoke extending from a first fastening portion of a rim to a second fastening portion offset against the former in the peripheral direction and being guided along the outside of the hub.

A solid carbon drive wheel, viz. a rear wheel, primarily excels by the fact that the rim is made of reinforcing fibers embedded in resin and the spokes are not made of steel or an aluminum alloy but equally consist of reinforcing fibers embedded in resin. In this way, an extremely light-weight and stiff wheel can be made available for a bicycle, i.e. a muscle-driven vehicle. Especially in the field of professionals, apart from the riding comfort also the stiffness and the light weight play an important role. In this respect, there is still room for improvement.

Traditionally, braking used to be performed on braking flanks including braking pads on the rim. This is a drawback in the case of solid carbon wheels, however, as wear of the braking flanks may entail abrasive effects and thus damage of the fibers. Also, in extreme riding situations, such as emergency braking during high-speed downhills, the temperature developing and, resp., the heat introduction into the rim is so high that delamination may occur.

It is the object of the present invention to provide an optimization and to eliminate or at least alleviate the known drawbacks.

This object is achieved in a generic apparatus in that the hub takes a shape polygonal in cross-section on the outside to which an axial side of each spoke is adjacent. This facilitates arranging brake disks so that extremely high forces can even be introduced without any rupture of individual component structures has to be expected. Numerous tests, even in most extreme situations, have shown that the forces transmitted by the brake pads to the brake disk, especially the torques then to be transmitted, can be efficiently transmitted via the hub shell and the spokes to the rim and in this way are beneficial to proper handling of a bicycle.

Advantageous embodiments are claimed in the subclaims and will hereinafter be explained in detail.

It is advantageous when each spoke only contacts a dedicated separate contact portion directly or by interposing additional resin. The force transmission is thus unexpectedly hugely improved.

It is also useful when a contact portion of a first spoke is spaced apart from a contact portion of a second spoke in the circumferential direction. This results in uniform flows of force.

When each contact portion has a straight/planar contact surface, the spoke is efficiently prevented from bending or breaking.

The fiber extension of each individual spoke is improved when a short connecting face relative to each contact face is arranged/provided between two contact portions, for example such short connecting face which is as long as the width of a spoke or approximately 0.75 times to 1.2 times as long as the width of a spoke. The length of the contact face measured in the tangential direction may be 3 to 5 times as large as the length of the short connecting face measured in the tangential direction.

An advantageous configuration is also characterized in that the spoke is in contact with the contact surface between two crossing areas with a respective other spoke. The force paths shown in tests then are optimized.

It is beneficial to the assembly when the hub is made of several parts and includes an external toothing sleeve on which a hub sleeve providing the contact portions for the spokes is mounted.

In order to ensure fail-safe use of the drive wheel even in a tough racing routine, it is advantageous when the hub includes a cover sleeve in portions covering some spokes. The rear wheel then may be designed to be especially robust.

It has proven of value when the spokes include reinforcing fibers of the group consisting of carbon fibers, glass fibers, aramid fibers or a mixture thereof.

Furthermore, it is of advantage when a first quantity of spokes is fastened close to a first front end of the hub to the latter and a second quantity of spokes is fastened to a second front end of the hub to the latter, the hub therebetween having an outer contour circular in cross-section. The assembly is facilitated in this way, as adjusting of the spokes of the first quantity relative to spokes of the second quantity is easily enabled by rotation.

It is also of advantage when all spokes of the first quantity and/or all spokes of the second quantity are adjacent to a polygonal shape or to either of two polygonal shapes.

It has proven of value when a brake disk is fastened to the hub, for example in the way of a closed ring. This allows to basically transmit higher forces, especially in rain-soaked conditions.

When the brake disk positively engages via a toothing engaging in the external toothing sleeve, for example, especially high forces can be transmitted.

It is advantageous when the spoke of the polygonal shape is in form closure and/or in force closure.

A good compromise between light-weight and stiffness is reached when five spokes are present for each axial side. Said five spokes then extend past the center of the wheel from the one side of the rim to the other side, preferably to the respective diametrically opposed side.

It is of advantage when the distance from one fastening portion to the next fastening portion is about 18° and the polygonal shape takes a pentagonal shape or that of a regular pentagon, when the short connecting faces are not taken into account.

Finally, the invention also relates to a bicycle comprising a drive wheel configured as a rear wheel of the type according to the invention.

Hereinafter, the invention shall be illustrated in detail by way of a drawing. Different embodiments are shown, wherein:

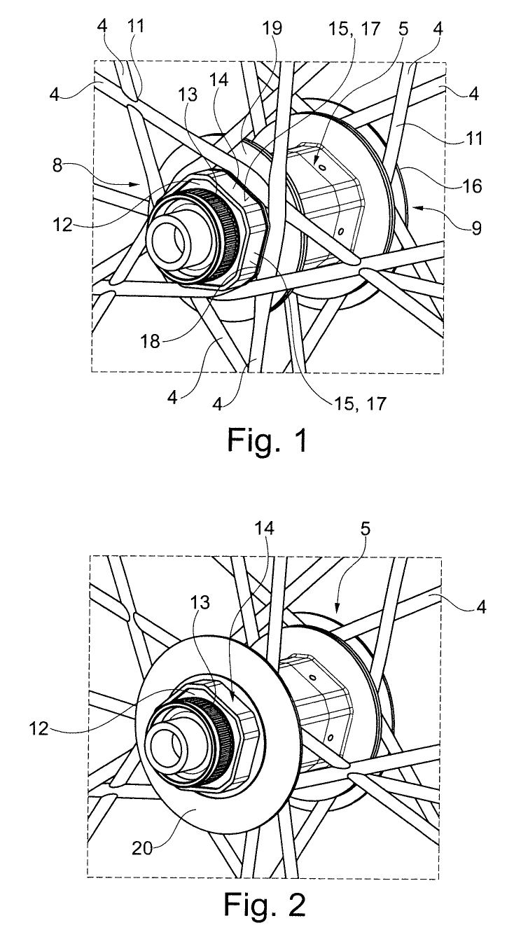

FIG. 1 shows a section of a drive wheel according to the invention close to the center, where the brake disk is not yet mounted and the cover sleeve is not yet mounted,

FIG. 2 shows the embodiment of FIG. 1 equally in a perspective representation but with the cover sleeve being mounted already,

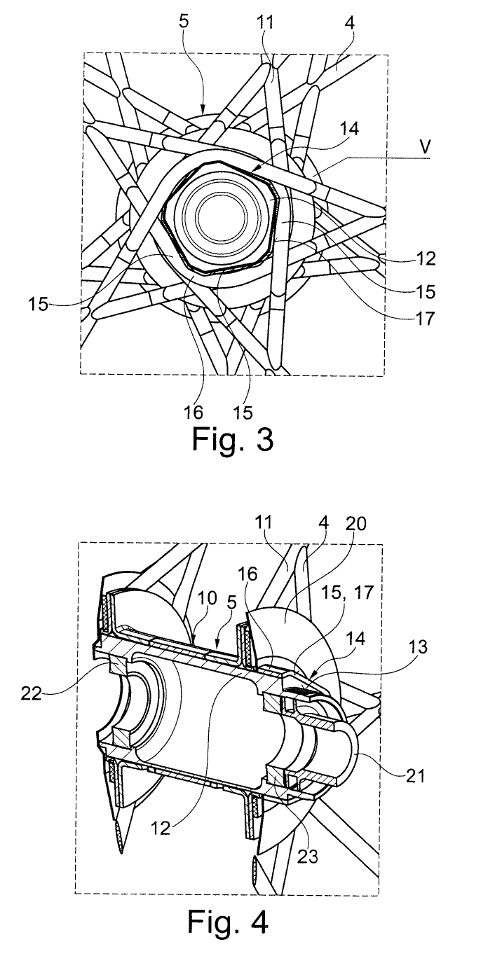

FIG. 3 shows a front view, i.e. in the longitudinal direction onto the embodiment with the cover sleeve being not yet mounted of FIG. 1,

FIG. 4 shows a slightly perspective longitudinal section across the embodiment of FIG. 2, viz. with the cover sleeve being mounted,

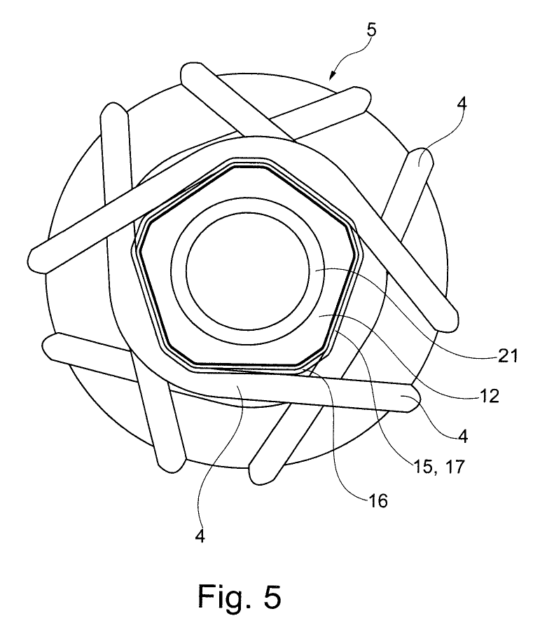

FIG. 5 shows an enlarged area V of FIG. 3, wherein only the spokes at a first end face and the pertaining parts of the hub are shown, however,

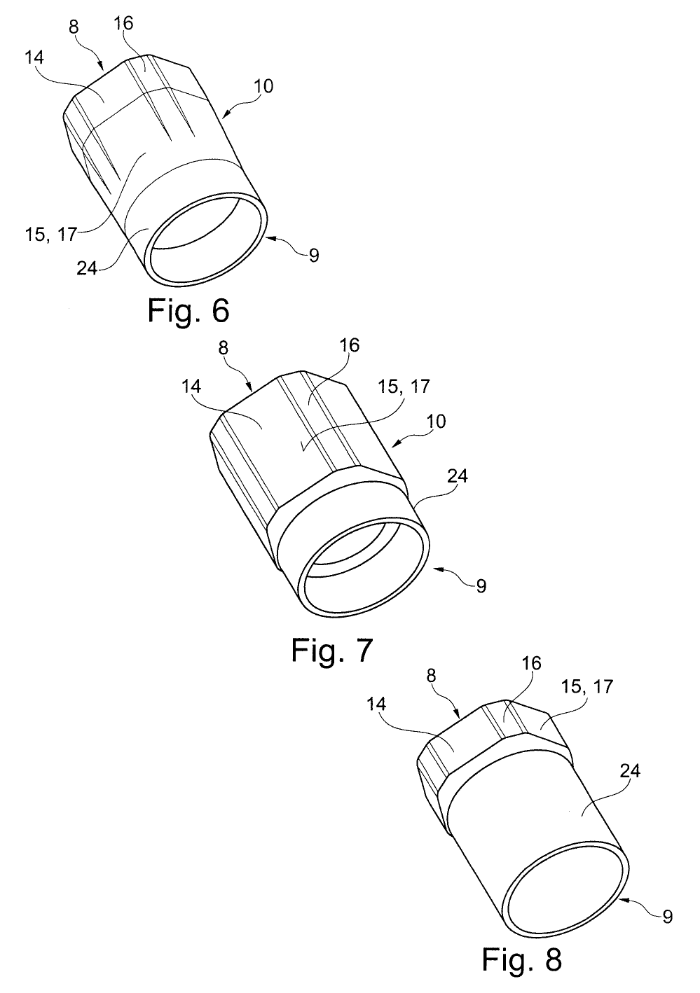

FIG. 6 shows another embodiment of a hub sleeve applicable to a drive wheel according to the invention,

FIG. 7 shows a second embodiment of a different hub sleeve,

FIG. 8 shows another embodiment of an applicable hub sleeve,

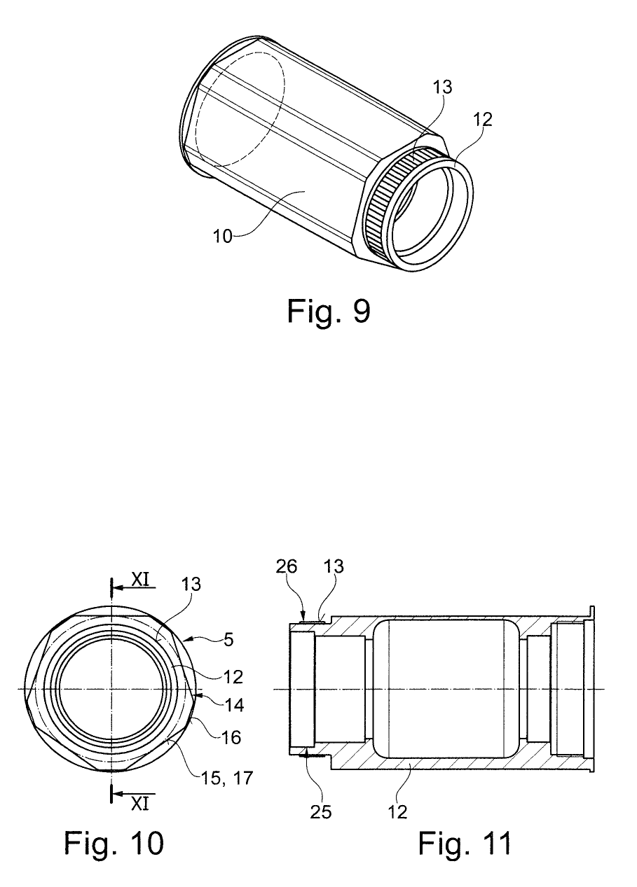

FIG. 9 shows the hub sleeve shown in perspective in FIGS. 6 to 8 of a type according to the invention, as it is employed in the embodiments of FIGS. 1 to 4, however,

FIG. 10 shows a view from the end face on the brake disk side onto the hub sleeve of FIG. 9,

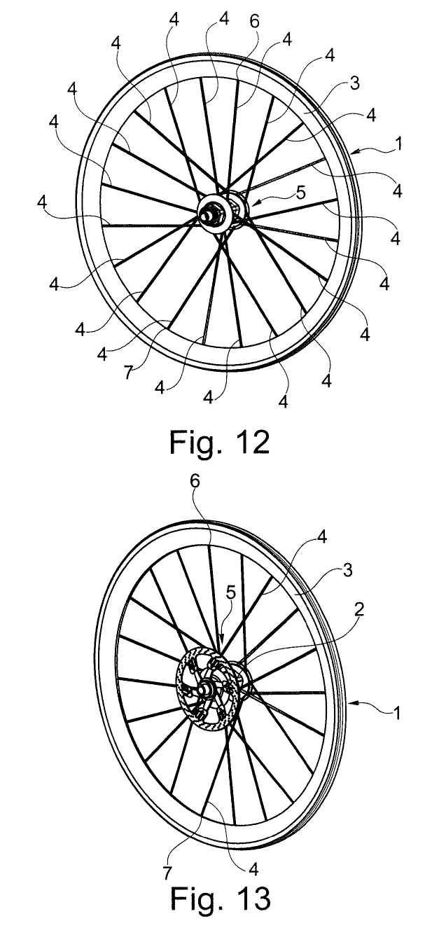

FIG. 11 shows a longitudinal section along the line XI of FIG. 10,

FIG. 12 shows a perspective view of the drive wheel according to the invention without a brake disk being mounted, and

FIG. 13 shows the drive wheel of FIG. 12 with the brake disk being mounted.

The Figures are merely schematic and only serve for the comprehension of the invention. Like elements are provided with like reference numerals. Features of the individual embodiments can be exchanged for each other.

In FIG. 1 an area close to the center of a drive wheel 1 according to the invention, especially of a rear wheel, is shown, wherein the complete drive wheel 1 is illustrated in FIG. 13 and the drive wheel 1 without a brake disk 2 as shown in FIG. 13 is illustrated in FIG. 12. From said two FIGS. 12 and 13 it is also evident that the drive wheel 1 includes a rim 3 which is connected to a hub 5 via a plurality of spokes 4, viz. twenty spokes 4. A spoke 4 extends from a first fastening portion 6 to a second fastening portion 7. The second fastening portion 7 is provided, viewed from the center of the drive wheel 1, on the diametrically opposite side.

Hence, ends of the reinforcing fibers of the spoke 4 are located, on the one hand, in the first fastening portion 6 and, on the other hand, in the second fastening portion 7. Each spoke 4 is completely made of resinated reinforcing fibers, i.e. carbon fibers and resin. A thermosetting resin or a thermoplastic resin is suggested as resin.

Referring to FIG. 1, half of the spokes 4 belong to a first quantity and half of the spokes 4 belong to a second quantity. The spokes 4 of the first quantity are fixed on a first front end 8 of the hub 5. The other half of the spokes 4, viz. the second quantity, is fixed on a second front end 9 of the hub 5. Accordingly, a hub sleeve 10 as shown in FIG. 9 is used.

Two spokes of the two quantities of spokes 4 at a time are crossing in a crossing area 11.

The hub 5 has an external toothing sleeve 12 inside the hub sleeve 10. Said external toothing sleeve 12 includes an external toothing 13.

The hub 5 takes a polygonal shape 14 on the outside. Said polygonal shape includes contact areas 15 which in the circumferential direction are adjacent to connecting faces 16. In turn, to each connecting face 16 a contact area 15 is adjacent by a contact face 17.

A spoke 4 contacts each contact face 17 by its longitudinal side/longitudinal edge 18. The spokes 4 of the first quantity of spokes 4 are located flatly at/on a flange 19. The flange 19 may be an integral or single-part or single-piece or single-material component part of the hub sleeve 10 or a component separate therefrom. The spokes 4 of the first quantity of spokes 4 are laminated/glued to the hub sleeve 10 and/or the flange 9. A form closure is produced between the hub sleeve 10 and/or the flange 19 as well as the spokes 4. Alternatively or additionally, also a force closure may be produced.

A condition comparable thereto is shown in FIG. 2, with a cover sleeve 20 being inserted, however.

The fact that the spokes 4 are in direct contact with the polygonal shape 14, especially with the contact faces/contact surfaces 17, is also clearly evident from FIG. 3.

In FIG. 4 the complete extension of the external toothing sleeve 12 through the hub sleeve 10 for forming the hub 5 is illustrated. An internal sleeve 21 is arranged adjacent to a bearing 22 and distal from another bearing 23. The two bearings 22 and 23 may be roller bearings or plain bearings. The use of roller bearings is preferred.

The spokes 4 contact the respective contact face/contact surface 17 without any gap, as far as possible, as is shown in FIG. 5.

FIGS. 6 to 8 illustrate that the polygonal shape 14 of a hub sleeve 10 need not absolutely project from one front end to the other. Accordingly, at the second front end 9 of the hub 5 and, resp., the hub sleeve 10 a circular outer area 24 is impressed or is present there.

A modified embodiment can be inferred from FIGS. 9 to 11. The external toothing sleeve 12 also includes a center-lock female thread area 25. There is also provided a center-lock receiving area 26.

1. A drive wheel for a bike, comprising a rim which is fastened to a hub by means of a plurality of spokes, wherein the spokes are made of reinforcing fibers embedded in resin, the reinforcing fibers of a spoke extending from a first fastening portion at the rim to a second fastening portion offset against the former in the circumferential direction and being guided along the outside of the hub, wherein the hub takes a shape polygonal in cross-section on the outside to which an axial side of each spoke is adjacent.

2. The drive wheel according to claim 1, wherein each spoke only contacts a dedicated separate contact portion directly or with additional resin being interposed.

3. The drive wheel according to claim 1, wherein a contact portion of a first spoke is spaced apart from a contact portion of a second spoke in the circumferential direction.

4. The drive wheel according to claim 2, wherein each contact portion has a straight/planar contact surface.

5. The drive wheel according to claim 2, wherein a short connecting face relative to each contact surface is arranged between two contact portions.

6. The drive wheel according to claim 4, wherein the spoke is in contact with the contact surface between two crossing areas each with another spoke.

7. The drive wheel according to claim 2, wherein the hub is made of several parts and includes an external toothing sleeve on which a hub sleeve providing the contact areas for the spokes is fastened.

8. The drive wheel according to claim 7, wherein the hub includes a cover sleeve in portions covering the spokes.

9. The drive wheel according to claim 1, wherein the spokes contain reinforcing fibers of the group consisting of carbon fibers, glass fibers, aramid fibers or a mixture thereof.

10. A bicycle comprising a drive wheel configured as a rear wheel according to claim 1.
